(19) United States
(12) Patent Application Publication
(10) Pub. No.: US 2011/0125068 A1
(43) Pub. Date: May 26, 2011

(54) Frequency Optimization for Chest Compression Apparatus

(76) Inventors: Leland G. Hansen, St. Paul, MN (US); Greg White, St. Paul, MN (US)

(21) Appl. No.: 12/869,736

(22) Filed: Aug. 26, 2010

Related U.S. Application Data
(60) Provisional application No. 61/237,112, filed on Aug. 26, 2009.

(51) Int. Cl. A61H 31/00

(52) U.S. Cl. 601/41

(57) ABSTRACT

A high frequency chest compression system for deriving one or more frequencies for a therapeutically-beneficial treatment protocol based on pressure measurements made via a mouthpiece. A routine for identifying optimal operating frequencies for an air pulse generator is also provided.

### RELATED APPLICATIONS

This application claims the benefit of U.S. Provisional Application No. 61/237,112, filed Aug. 26, 2009, and incorporated herein by reference.

### TECHNICAL FIELD

The present invention relates to high frequency chest compression (HFCC) devices and systems and more particularly to an air pulse delivery system having configurable operating modes. The present invention further relates to machine-integrated or hand-held interface devices adapted to evaluate patient air flows across a range of HFCC frequencies to determine one or more optimum frequencies for operation.

### BACKGROUND OF THE INVENTION

A variety of high frequency chest compression (HFCC) devices have been developed to aid in the clearance of mucus from the lung. Such systems typically involve the use of a pulsed-air delivery device in combination with a patient-worn vest. Such systems were initially developed for patients with cystic fibrosis to provide airway clearance therapy. The vest is coupled to an air pulse generator that provides air pulses to the vest during inspiration and/or expiration. The air pulses produce transient cephalad air flow bias spikes in the airways, which moves mucous toward the larger airways where it can be cleared by coughing. The prior vest systems differ from each other, in at least one respect, by the valves they employ (if any), and in turn, by such features as their overall weight and the wave form of the air produced.

Examples of HFCC systems are disclosed in U.S. Pat. Nos. 6,958,046, 7,597,670 and 7,762,967, each entitled Chest Compression Apparatus, and each patent being incorporated for all purposes herein.

### SUMMARY OF THE INVENTION

The present invention is generally directed to a chest compression apparatus for applying a force to the thoracic region of the patient. More particularly, the present invention is directed to an apparatus and method for evaluating a patient parameter across a range of applied HFCC frequencies and determining an optimum frequency range based on the evaluated parameter.

In one embodiment, the evaluated patient parameter includes an induced airflow measurement. A hand-held interface device is coupled to a patient mouth piece via a pair of sensing ports on opposite sides of an internal flow restriction. A pair of air lines is coupled between the sensing ports and the interface device.

In another embodiment, the mouth piece is integrated within a hand-held interface device to provide a single hand-held device into which a patient breathes.

In another embodiment, the mouth piece is coupled directly to a HFCC device via, for example, flexible air lines, with internal circuitry and/or software of the HFCC performing a frequency analysis as described herein.

The present invention includes a method of evaluating induced airflows during a therapy session for optimization of a HFCC therapy. A preferred range of HFCC frequencies is determined based on the airflow evaluation across a range of frequencies.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows one embodiment of an air pulse generator, mouthpiece and interface device;

FIG. 2 shows the mouthpiece and interface device in patient use;

FIGS. 3-5 show various views of the mouthpiece of FIG. 1;

FIG. 6 depicts the components of FIG. 1 as during patient use;

FIG. 7 shows the relationship between measured volts and flow rates of the mouthpiece of FIG. 1;

FIG. 8 is a graph illustrating measured volts versus time for a period of inhalation and exhalation of a patient using the apparatus of FIG. 1

FIG. 9 is a table relating frequency to average measured volts

FIG. 10 is a graph illustrating average measured volts versus frequency;

FIG. 11 depicts an air pulse generator coupled to a patient vest;

FIGS. 12-13 are views of air pulse generator components;

FIG. 14 is a perspective view of air pulse generator components; and

FIG. 15 is a diagrammatic illustration of the embodiment of FIG. 1.

### DETAILED DESCRIPTION OF THE INVENTION

An embodiment of the present invention provides a mouthpiece and method of using same with a HFCC system, such as described above and in patents incorporated by reference herein. The mouthpiece can be coupled to an interface device via a pair of air lines. The mouthpiece, via an internal flow restricting structure, establishes a pressure differential which is communicated to the monitoring device. During patient breath cycles, the mouthpiece functions to accurately and consistently provide a pressure differential to the monitor for conversion into a patient-usable format. One aspect of the monitoring device is the provision of data analyses, for example to provide a frequency analysis and report of the information to the patient.

HFCC therapy is considered an effective aid in mucus clearance in patients with obstructive lung disease. There is some debate among medical personnel and machine manufacturers as to which HFCC frequencies should be used to maximize the effectiveness of therapy. It is generally considered that those frequencies that produce the highest induced air flows at the mouth are the most effective.

High frequency chest compression has been shown to enhance clearance of mucus secretions in pulmonary airways. Some investigators consider induced velocity of the airflow measured at the patient's mouth to be a useful indicator of efficacy. Studies using the in Courage® HFCC system (ICS), manufactured by Respiratory Technologies, Inc., have shown the greatest induced flows and largest induced expiratory volumes occur over the same frequency range of 6 to 15 HZ. It has also been shown that within that range there are a number of individual frequencies that induce higher air flow rates than others in the same frequency range. Those individual frequencies that produce the highest induced air flow rates are considered the most effective in clearing mucus from the airways. Identifying the most effective frequencies allows the patient to individualize his or her therapy around those frequencies. Under these conditions therapy would have maximum effect and potentially allow the patient to reduce therapy time.

With the in Courage® HFCC system (ICS) the highest induced air flow and the largest induced air volumes generally occur over the same frequency range, between 6 and 15 Hz. With all other HFCC devices the highest induced air flows occur above 15 Hz and the largest induced volumes occur below 15 Hz.

When using the ICS there are a number of frequencies in the 6 to 15 Hz range that produce higher than average air flows, when measured at the mouth. These high individual induced flow rate frequencies vary from patient to patient and from day to day within the same patient. In order to maximize therapy effectiveness, a method was devised of identifying five frequencies in the 6 to 15 Hz range which induce higher air flows than others when measured at the patient's mouth. Knowing which frequencies produce the highest induced flow allows the patient or care giver to customize each patient's therapy regimen. The patient may choose to use just the high flow frequencies identified or program the machine to dwell for a period of time over the selected frequencies while ramping through the 6 to 15 Hz cycle.

A patient mouth piece with a flow restriction is fitted with sensing ports located between the patient's mouth and the restriction. The sensor ports on the mouth piece are connected to a positive pressure sensor and connected to a micro processor. In one application the patient breathes normally through the mouth piece while receiving one ramped cycle of HFCC therapy. Cycle time may be about 2 or 3 minutes. A complete 6 to 15 Hz therapy cycle is useful to identify the frequencies that produce the highest induced pressure pulses. The induced pressure pulses at each frequency are recorded and the average amplitude is calculated for each HFCC frequency so that optimal frequencies may be identified.

The mouthpiece interface device identifies frequencies that produce the highest HFCC induced flows. In operation, the user breathes through a sensor tube (mouth piece) while receiving a complete therapy cycle of 6 to 15 Hz. The induced air flow pulse is measured at each frequency over the frequency range and a mean induced air flow rate calculated for each frequency. The frequencies that produce high induced flow rates are considered most effective for that patient. This data is used to program the ICS system so that during the therapy cycle of 6 to 15 Hz, additional time is spent at those high flow rate frequencies or the patient may choose to concentrate on those frequencies alone. Reduced therapy times may result from such therapy optimization.

The HFCC system may be implemented with a mouthpiece and interface device for the purpose of making an airflow assessment of a patient. A patient airflow assessment may be made during a HFCC therapy to determine optimum settings for the HFCC therapy, which optimum settings may change from time to time based on the condition of the patient. The optimum settings for a HFCC therapy may include the frequency range of the air pulses applied to the vest. In addition, a patient airflow assessment may be made periodically during the HFCC therapy session to evaluate a patient's progress.

The mouthpiece interface device may be located within the HFCC device housing or provided as a separate hand-held device. The mouthpiece interface device can be coupled to or be in communication with the controller of the HFCC system. In one embodiment of the invention, the interface provides a preferred range of HFCC frequencies to a user or caregiver who then enters the preferred range at the HFCC system interface.

The circuitry of interface device includes one or more transducers for measuring attributes of the patient's inhalation (also referred to herein as “inspiration”) and exhalation (also referred to herein as “expiration”), such as pressure. The measurements for a patient may be made with or without the patient undergoing the HFCC therapy during the airflow evaluations.

To determine the optimum settings for the HFCC therapy for a patient, a patient wearing a HFCC therapy vest is seated comfortably in a certain position, the air pulse generator is turned on to apply air pulses to the vest, the mouthpiece is inserted into the patient's mouth and the patient starts breathing through his mouth (nose pinched). The interface device converts the patient's breath into digital values which are processed by the software included in the interface device. The output can be provided as frequency components obtained using standard filtering techniques.

Frequency components of the patient's airway pressure waves are analyzed using standard software filtering techniques to determine a preferred range of frequencies. Once the preferred range of frequencies has been identified, the HFCC therapy can be customized. In some embodiments, the software included in the HFCC system automatically adjusts the air pulse frequency for optimum HFCC therapy based on communication from the interface device.

The HFCC system may wirelessly communication with the interface device. In other embodiments, the interface device simply identifies a preferred range of frequencies and the patient or caregiver programs the HFCC system to operate within the frequency range.

The HFCC system provides a force applying mechanism including a vest or other wearable air chamber for receiving pressurized air. The apparatus further includes a mechanism for supplying pressure pulses of pressurized air to the vest. For example, the pulses may have a sinusoidal, triangular, or square wave form, among others. Additionally, the apparatus includes a mechanism for venting the pressurized air from the bladder.

In the ICS device a fan valve is used to establish and determine the rate and duration of air pulses entering the vest from the pressure side and allow air to evacuate the bladder on the depressurizing side. An air generator (e.g., blower) is used on the pressurizing side of the fan valve. The fan valve advantageously provides a controlled communication between the blower and the bladder.

The ICS device includes a housing having a port, a therapy system carried by the housing and operable to deliver HFCC therapy to a patient in accordance with a set of operating parameters, and a memory device coupled to the port and configured to store at least a portion of the set of operating parameters. The therapy system may be operable in accordance with the portion of the set of operating parameters stored in the memory device. The memory device may comprise a read/write memory. Alternatively or additionally, the memory device may comprise a read-only memory.

The memory device may store one or more of a plurality of pre-programmed therapy modes to allow a caregiver to deliver HFCC therapy to a patient in accordance with any one of the plurality of pre-programmed therapy modes stored in the memory device. The plurality of pre-programmed therapy modes may comprise a step program mode, a sweep program mode, a training program mode, and the like. Alternatively or additionally, the memory device may store one or more of a plurality of customized therapy modes to allow a caregiver to deliver a customized HFCC therapy to a patient in accordance with any one of the plurality of customized therapy modes stored in the memory device. The memory device may store information regarding functionalities available to a patient. The functionalities available to a patient may comprise a positive expiratory pressure (PEP) therapy, a nebulizer therapy, an intermittent positive pressure breathing (IPPB) therapy, a cough assist therapy, a suction therapy, a bronchial dilator therapy, and the like.

A user interface apparatus of the HFCC therapy system may include a touch screen display on the housing. The display may be signaled by software of the therapy system to display a data download screen. The data download screen may comprise a patient list and a list of device selection buttons. The patient list may comprise patient ID numbers. Each device selection button may be associated with one of the plurality of devices. The plurality of devices may comprise one or more of physiological sensors, a printer, a PC, a laptop, a PDA button, and the like. One or more of the plurality of devices may be associated with a computer network of a hospital. The data relating to HFCC therapy delivered to a patient may comprise one or more of the following: a type of the HFCC therapy, the settings of the various operating parameters associated with the HFCC therapy, data associated with any tests or assessments of the patient, including graphs and tables of such data, date and time of the therapy, and patient personal information.

The system may further comprise a wireless receiver carried by the housing and operable to wirelessly receive information from a hand-held frequency analysis interface device as described above. The system may be operable to wirelessly receive updates relating to preferred frequency ranges for a given HFCC therapy session. The wireless transmitter and/or the wireless receiver may be included as part of a wireless transceiver. The wireless transmission of the data may be in accordance with known protocols. Alternatively, the housing may include a data port to receive information from the hand-held frequency analysis device. Alternatively, the user may simply input frequency analysis information from the hand-held device into the HFCC device.

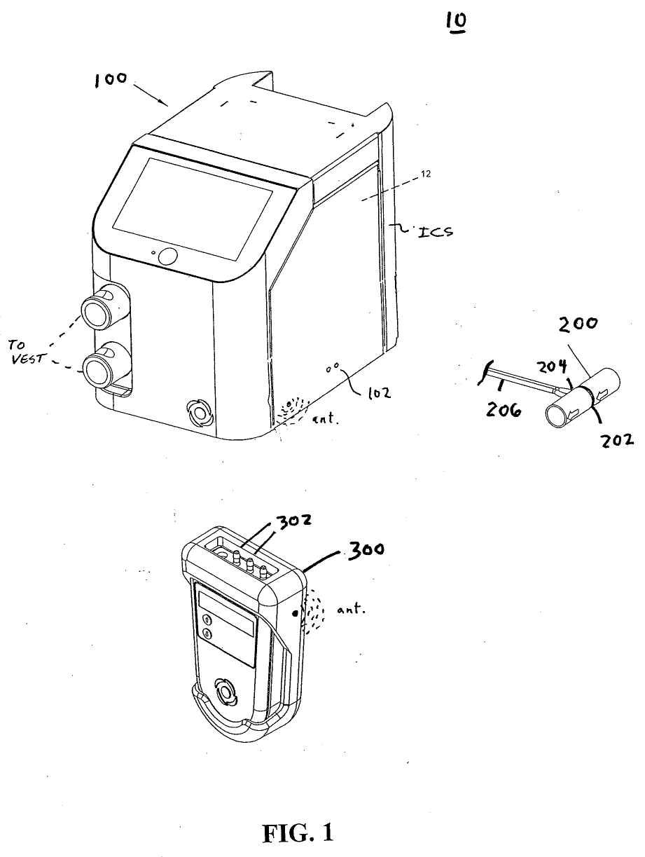

FIG. 1 depicts a HFCC system 10 in accordance with the present invention. System 10 includes air pulse system 100, such as the ICS device, and a mouthpiece 200 adapted to be inserted into or cover a patient's mouth during expiration. The mouthpiece 200 is in communication with an interface device 300. Mouthpiece 200 is a hollow, generally cylindrical form including a flow restricting structure, such as a ring 202, inside the mouthpiece 200. A pair of air ports 204 are provided on either side of the flow restricting structure. The air ports 204 are coupled via airlines 206 to ports 302 on a hand-held interface device 300. Interface device 300 may include a variety of displays relating to measured values, previous values, etc. Device 300 includes at least one pressure transducer in communication with ports 302 and software for performing a variety of evaluations on the data collected, including but not limited to frequency analyses. In another embodiment, interface device 300 may be incorporated within the housing of the air pulse system 100. In such an embodiment, the mouthpiece air lines 206 are coupled via air ports 102.

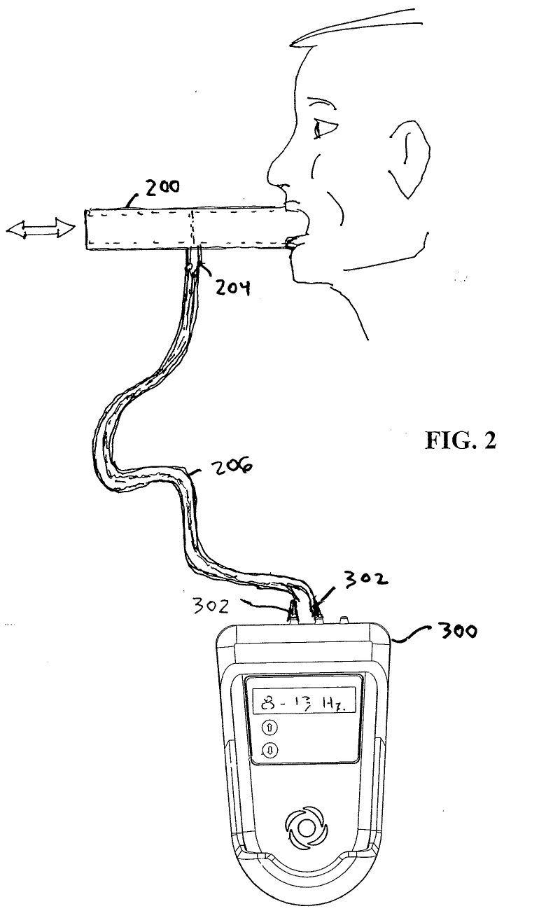

FIG. 2 is a depiction of a patient utilizing the mouthpiece 200 and interface device 300. As described above, the mouthpiece and interface device are used during a HFCC therapy session.

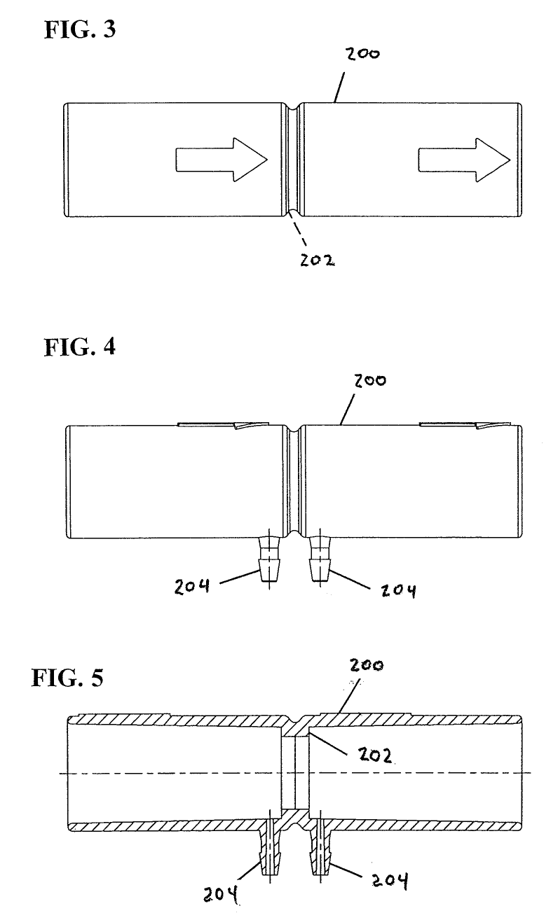

FIGS. 3-5 are various views of the mouthpiece 200. FIG. 5 is a cross-sectional view of a mouthpiece 200. As shown, mouthpiece 200 includes a generally cylindrical and hollow form. Flow restricting structure, ring 202, interrupts the flow of air through the mouthpiece 200 and establishes a pressure differential between the pair of air ports 204. The pressure differential signal is communicated to device 300 via air lines 206.

In an alternative embodiment, mouthpiece 200 includes a single air port 204. During use, the air port 204 is positioned between the flow restricting structure 202 and the patient. A single air line would connect the mouthpiece to the interface device.

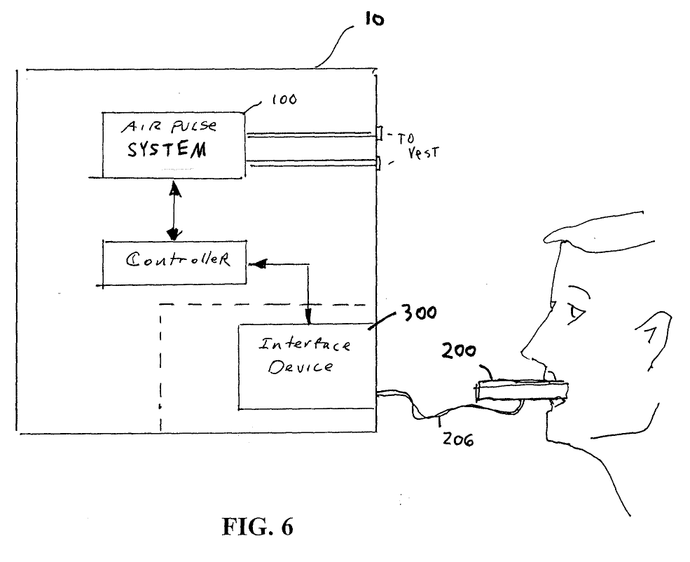

FIG. 6 is a depiction of a patient utilizing a HFCC air pulse system 100, mouthpiece 200 and interface device 300. The interface device may be provided as a separate hand-held device or may be integrated within the HFCC air pulse system 100.

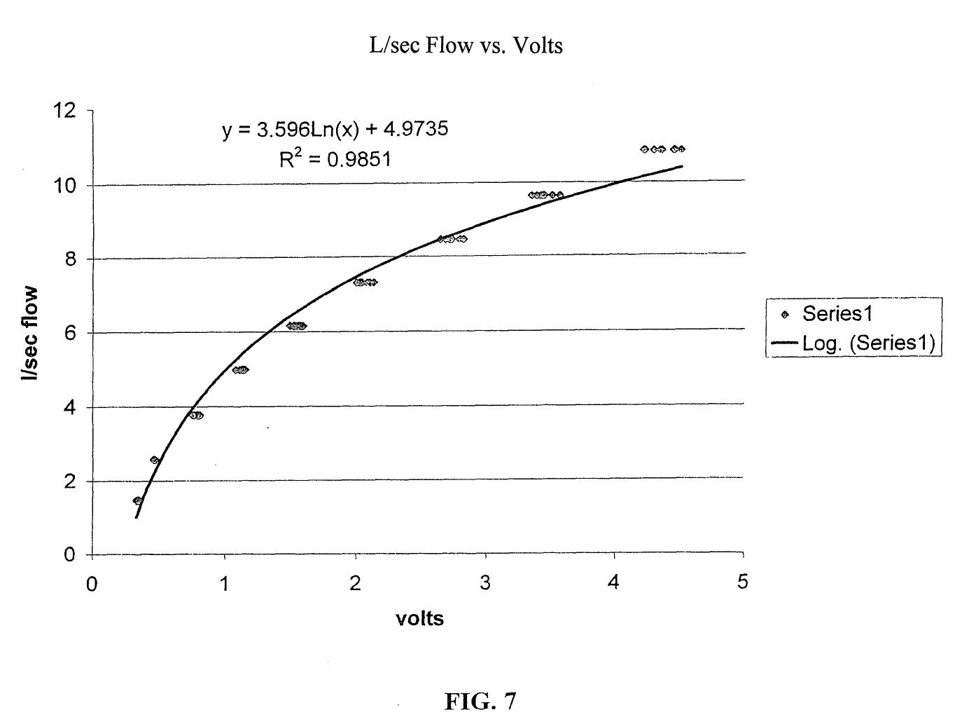

FIG. 7 is a graph relating airflow in liter per second versus volts (of a differential pressure sensor) of an experiment using mouthpiece 200. As shown, the mouthpiece yields accurate and consistent measurements over the 0-12 liters per second range. The internal diameters of the mouthpiece, including ring 202, may be varied depending on the application.

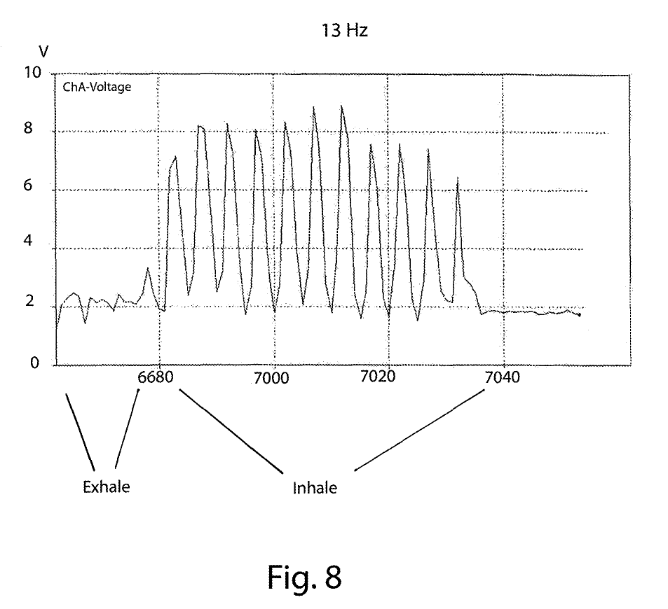

FIG. 8 is a graph illustrating measured voltages from a pressure sensor, over time, during a period of inhalation and exhalation. The pulses correspond to pressure pulses applied to the patient via the HFCC vest. FIG. 8 illustrates an example in which the pulse frequency is 13 Hz. The pressure pulses during inhalation are significantly less noisy than the pressure pulses measured during exhalation. In one system, the interface device 300 would utilize pressure information only during inhalation.

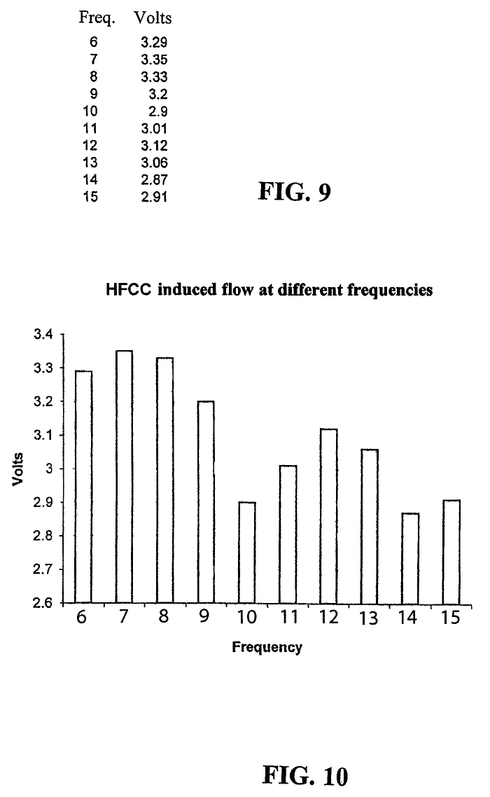

FIG. 9 provides a general representation of the relationship between airflow and measured volts using a mouthpiece in accordance with the present invention.

FIG. 10 is a graph relating measured volts (from pressure transducer) to airflow frequencies, with the measured volts corresponding to HFCC induced airflows.

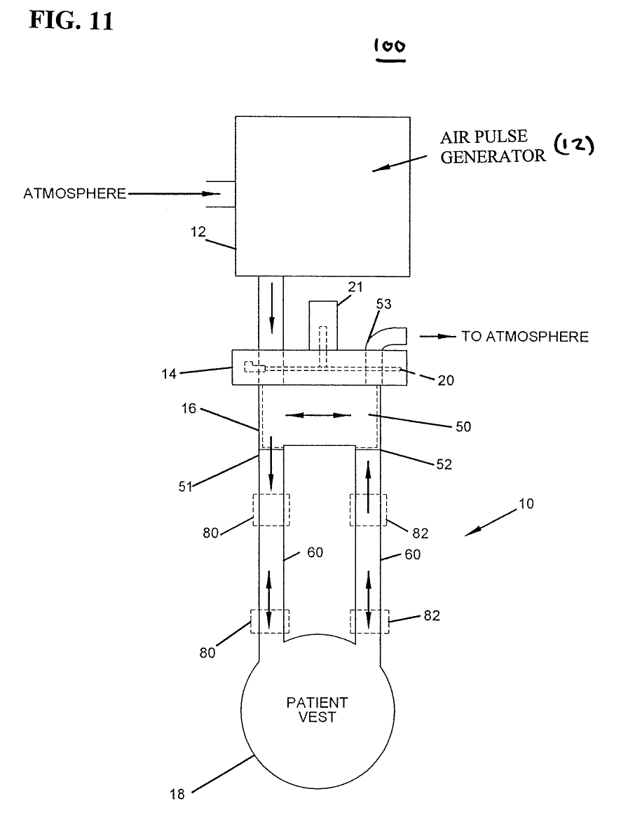

FIG. 11 is a somewhat diagrammatical air flow diagram associated with air pulse system 100. Air pulse system 100 includes an air pulse generator component 12, flowably connected to a pulse frequency control module 14, which in turn is flowably connected to a pressure control device 16, and finally to a vest 18 worn by the patient. The patient may be a human or other animal. For example, both human and equine applications may be practicable, with differently sized vests 18 being defined by the particular applications. In use, the air pulse generator (e.g., motor driven blower) delivers pressurized air to vest 18, via pulse frequency control unit 14 that preferably includes one or more rotating (e.g., fan-like) blades. Air pulse generator 12 includes an electric blower, the speed of which may be fixed or variable.

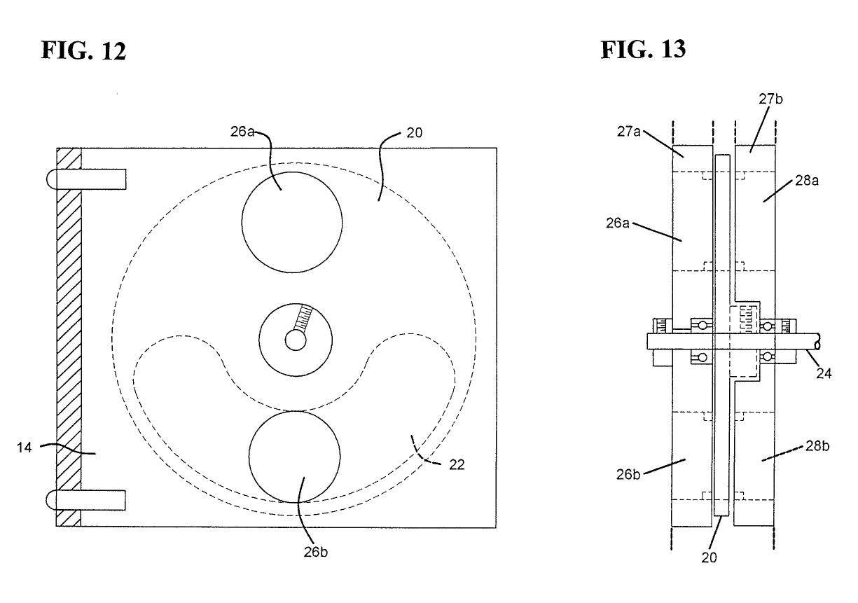

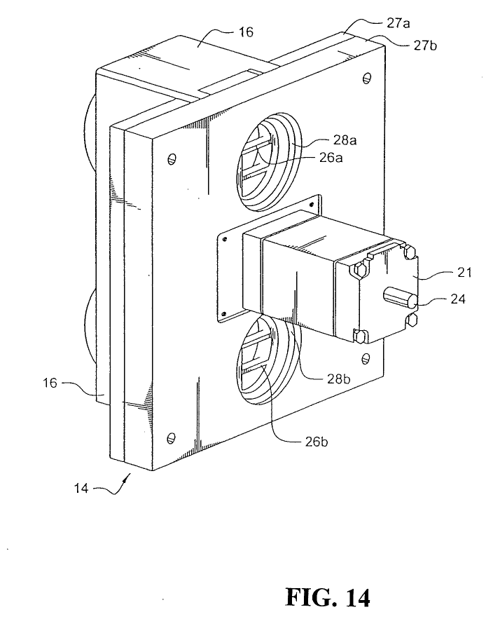

FIGS. 12-14 illustrate aspects of a pulse frequency control unit. The unit includes a generally circular valve blade 20, rotatable upon a central axis of motor 21 (shown in FIG. 14) and having one or more cutout portions 22. Blade 20 is retained on a centrally located motor driven shaft 24, which serves to rotate blade 20, and in turn, provide airflow access to and through air ports 26a and 26b, respectively. Motor 21 (shown in FIG. 14) is coupled to motor shaft 24 and provides rotational control of blade 20. Motor 21 is a stepper motor providing accurate control of the position of blade 20 in order to define particular waveforms applied to vest 18. As shown in corresponding FIG. 13, a pair of plates 27a and 27b are mounted on an axis concentric with that of motor drive shaft 24, and effectively sandwich the blade assembly between them. The end plates are provided with corresponding air ports 26a and 26b (in plate 27a) and 28a and 28b (in plate 27b). The air ports are overlapping such that air delivered from the external surface of either end plate will be free to exit the corresponding air port in the opposite plate, at such times as the blade cutout portion of the valve blade is itself in an overlapping position there between. By virtue of the rotation of cutout portions past the overlapping air ports, in the course of constant air delivery from one air port toward the other, the rotating fan blade effectively functions as a valve to permit air to pass into the corresponding air port in a semi-continuous and controllable fashion. The resultant delivery may take a sinusoidal, triangle or sawtooth wave form, by virtue of the shape and arrangement of the fan blade cutout portions.

Pulse frequency module 14, in a preferred embodiment, is provided in the form of a motor-driven rotating blade 20 (“fan valve”) adapted to periodically interrupt the air stream from the air pulse generator 12. During these brief interruptions air pressure builds up behind the blade. When released, as by the passage of blade 20, the air travels as a pressure pulse to vest 18 worn by the patient. The resulting pulses can be in the form of fast rise, sine, triangle or sawtooth wave pressure pulses. Alternative waveforms can be defined through accurate control of blade 20, such as via an electronically controlled stepper motor. These pulses, in turn, can produce significantly faster air movement in the lungs, in the therapeutic frequency range of about 5 Hz to about 25 Hz, as measured at the mouth. In combination with higher flow rates into the lungs, as achieved using the present apparatus, these factors result in stronger mucus shear action, and thus more effective therapy in a shorter period of time.

Fan valve 20 of the present invention can be adapted (e.g., by configuring the dimensions, pitch, etc. of one or more fan blades) to provide wave pulses in a variety of forms, including sine waves, near sine waves (e.g., waves having precipitous rising and/or falling portions), and complex waves.

The pulses can also include one or more relatively minor perturbations or fluctuations within and/or between individual waves, such that the overall wave form is substantially as described above. Such perturbations can be desirable, for instance, in order to provide more efficacious mucus production in a manner similar to traditional hand delivered chest massages. Moreover, pulse frequency module 14 of the present invention can be programmed and controlled electronically to allow for the automatic timed cycling of frequencies, with the option of manual override at any frequency.

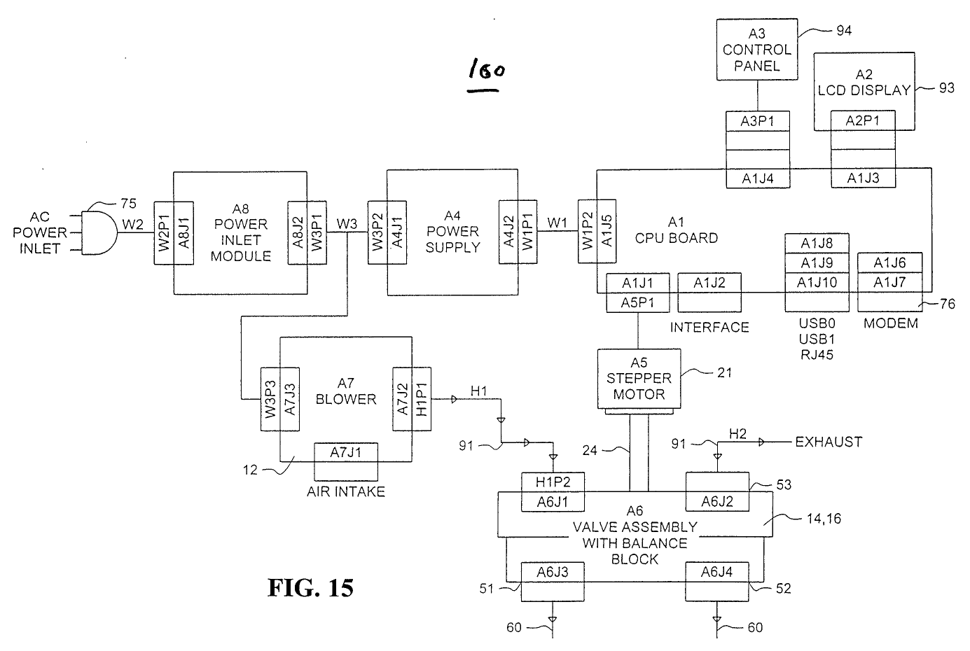

FIG. 15 illustrates a somewhat diagrammatical schematic of an electronic controller 160 of air pulse system 100. Controller 160 provides control of stepper motor 21 providing rotational control of blade valve 20. With frequency analyses input from the mouthpiece interface device 300, controller 160 may adjust one or more operational parameters of system 100. For example, controller 160 may change the speed of motor 21 as a function of patient airway as indicated by the mouthpiece data.

The patient may be prompted to use mouthpiece device 200 by a visual and/or auditory cue provided by air pulse system 100. For example, a variety of visual displays may illustrate to the patient the correct manner of use, via for example a video displayed on a panel. The visual display may also facilitate proper use of the mouthpiece interface by indicating proper airflow and providing an alarm when, for example, the airflow is insufficient to provide an accurate reading or the airflow is reversed.

The controller 160 may signal the air pulse generator to deliver air pulses of a predetermined frequency and/or duration to a patient in accordance with the portion of the set of operating parameters stored in a memory device. In some embodiments, the memory device is configured to store one or more of a plurality of pre-programmed therapy modes to allow a caregiver to deliver HFCC therapy to a patient in accordance with any one of the plurality of pre-programmed therapy modes stored in the memory device. Examples of the pre-programmed therapy modes include a step program mode, a sweep program mode, a training program mode, and the like. The step and sweep program modes are substantially as described in U.S. Ser. No. 11/520,846, incorporated by reference herein. A program mode allows the caregiver to start at a desired starting frequency and/or intensity for the HFCC therapy and automatically change the frequency and/or intensity over a predetermined period of time or a programmed period of time to a desired maximum frequency and intensity.

Air pulse system 100 may include a memory device configured to store one or more of a plurality of customized therapy modes to allow a caregiver to deliver HFCC therapy to a patient in accordance with any one of the plurality of customized therapy modes stored in the memory device. In the custom program mode, the caregiver is able to create a special waveform for a particular patient's therapy. Such a special waveform may be in accordance with wave type, frequency, pressure, and timing parameters of the caregiver's choosing or may be in accordance with a menu of special waveforms preprogrammed into the system. In still other embodiments, a memory device is configured to store information regarding functionalities available to a patient. Examples of functionalities available to a patient include one or more of a positive expiratory pressure (PEP) therapy, a nebulizer therapy, an intermittent positive pressure breathing (IPPB) therapy, a cough assist therapy, a suction therapy, a bronchial dilator therapy, and the like.

Although the present invention and its advantages have been described in detail, it should be understood that various changes, substitutions and alterations can be made herein without departing from the spirit and scope of the invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A HFCC system comprising:
a variable-frequency HFCC air pulse generator;
a patient-worn air garment in communication with the air pulse generator;
a mouthpiece accessory adapted to be inserted in the mouth of a patient; and
a mouthpiece interface device in communication with the mouthpiece, said interface device adapted to evaluate HFCC induced air flows through the mouthpiece accessory and determine one or more preferred frequency ranges of operation of the air pulse generator.

2. A method of determining a preferred range of air pulse frequencies to be applied to a patient during a HFCC therapy session comprising:
providing a mouthpiece accessory to the patient;
capturing HFCC induced airflow information of the patient using the mouthpiece accessory and an interface device while the patient is undergoing an HFCC therapy session; and
evaluating the airflow information to determine one or more ranges of air pulse frequencies to be applied to the patient.

3. A method of performing an HFCC therapy comprising:
providing a variable frequency HFCC air pulse generator to a patient;
providing a mouthpiece accessory to the patient;
capturing HFCC induced airflow information of the patient using the mouthpiece accessory and an interface device;
evaluating the airflow information to determine one or more ranges of air pulse frequencies to be applied to the patient; and
changing a parameter of the HFCC air pulse generator based on said determined air pulse frequencies.
